(19) United States
(12) Patent Application Publication
(10) Pub. No.: US 2016/0261695 A1
(43) Pub. Date: Sep. 8, 2016

(54) Systems and Assemblies of Fasteners, Connectors, and Devices to Affix and Communicate Information

(71) Applicants: Kevin Schaff, (US); Charle Rinzler, (US); Ryan McKay, (US); Yeshaya Koblick, (US)

(72) Inventors: Kevin Schaff, Greenwood Village, CO (US); Charles Cooper Rinzler, Cambridge, MA (US); Ryan McKay, Littleton, CO (US); Yeshaya Koblick, Sharon, MA (US)

(21) Appl. No.: 15/061,221

(22) Filed: Mar. 4, 2016

Related U.S. Application Data
(60) Provisional application No. 62/128,185, filed on Mar. 4, 2015.

(51) Int. Cl. H04L 29/08; B65D 33/06; H04B 5/00; A45C 13/10; A45C 3/06; A44B 17/00; A45C 5/03

(52) U.S. Cl. CPC H04L 67/12; A44B 17/0011; A44B 17/0041; A44B 17/0076; A44B 17/007; B65D 33/06; A45C 5/03; A45C 13/10; A45C 3/06; H04B 5/0062; H04B 5/0075

(57) ABSTRACT

There is provided a system and apparatus comprising a fastener component of novel geometry. There is further provided systems and apparatuses comprising a fastener component that communicates information in additional to providing mechanical attachment. There is still further provided novel substrates for fastener systems and assemblies.

This application claims priority to provisional application 62/128,185 filed on Mar. 4, 2015.

### BACKGROUND OF THE INVENTION

1. Field of the Invention

The present inventions relate to methods, devices, and systems to fasten or affix objects together. They further relate to communicating information through the components of fastener systems. Thus, herein described inventions relate to the fields of the “Internet of Things”, smart devices, and fasteners.

2. Terms and Definitions

Mobile Object will be herein defined to mean any object able to be carried by an individual and capable of associating, affixing, or placing items in or on the object. Examples may include, but are not limited to, bags, handbags, suitcases, carts, boxes, and more.

Accessory will be herein defined to mean any object that is intended for use in association with a predetermined mobile object such as a handbag. Examples include decorative tassles, mirrors, straps, and more.

Attacher will be herein defined to mean an object capable of attaching to a predetermined second object my mechanical means.

Substrate will be herein defined as any element capable of mechanically supporting an attacher. Examples include bags, walls, dashboards, and more.

Female Object will be herein defined to mean an object comprising an attacher and affixed to a substrate and capable of attaching to a male object.

Male Object will be herein defined to mean an object comprising an attacher and affixed to a substrate and capable of attaching to a female object.

Male Component will be herein defined to mean a component comprising an attacher and affixed to a substrate and capable of attaching to a female component.

Female Component will be herein defined to mean a component comprising an attacher and affixed to a substrate and capable of attaching to a male component.

Storage Device will be herein defined to mean an object that stores electronic information, such as memory.

3. Discussion of Related Art

Fasteners have long been considered a ‘dead’ space for invention and innovation. Many generations of iteration have resulted in a set of modern mechanical fastener designs that serve purpose to affix or attach various object, or as elements of design or clothing. However, advances in electronic and information technologies have enabled the reimagination of the connectivity of many objects in the home and workplace over the last 20 years. The “Internet of Things” is often discussed as the next step in the evolution of connected technology. However, it has been heretofore unobtainable to connect many objects in the home or workplace via informational communication. We herein address, solve, and disclose invention of novel methods, systems, and assemblies to connect objects mechanically and informationally.

### BRIEF SUMMARY OF THE INVENTION

The definition of a fastener is a hardware device joining two objects together. This is a common device that is considered a static technology. However, there is an interest within the fashion, industrial, and consumer industries to upgrade the fastener with advances to aesthetics, remain low-cost, and support heavy loads of objects in defined orientations. Additionally, there is the goal for objects to be intelligent and able to communicate information with or to a device, computer and/or computing network for the purpose of performing decision making, authorization, identification analytics, usage of wear and other use. Objects such as, but not limited to, fasteners have remained passive objects. It is the objective to add “smart features” to the fasteners and “smart features” to other objects, where an embodiment of object is it may connect to the fasteners, where this information can be used.

There is the need for novel fasteners for use in fashion, industrial, consumer, and other applications to have novel methods and apparatus to join two or more objects together. Of the two objects, one is called the male, which attaches to the second object, the female. The fasteners of invention are durable, low cost, load bearing, and with unique designs of using flaps, springs, magnetic, and related methods and a range of rotational, translational, de/compression, or related motions as a single or multiple to connect the male object to the female object and disconnect the male object to the female object.

It is an additional aspect of the fastener to be “smart” whereby information is passively or actively transferred before, during, or after the male object and female object is fastened. The male object as an embodiment is attached to another object, such as but not limited to, a mobile device, bag flap, and strap. The female object as yet another embodiment is attached to another object, such as but not limited to, a mobile device, bag flap, sensor, wireless chip, and strap. The method of processing the information includes, electrical, optical, mechanical, visual, and magnetic. The information is received by at least one electronic device because of predefined event such as the fastener male object connects to the female object or de/connects, whereby, this information is processed or lights up an LED/display, e-ink, sensor or electronic device, which may interface with the fastener by wire and/or wireless communication. It is another embodiment that the connection is not just mechanical, but magnetic or electrical.

This identified electronic information may be read by an interrogator that is optical, electronic, or related and sent to/from an electronic device for the purpose of authorization, identification, interrogation, or related use.

### BRIEF DESCRIPTION OF THE DRAWINGS

FIG. 1 shows a diagram of a male object with substrate and attacher, it also shows a female object with substrate and attacher, these are attached where the male attacher and female attacher join.

FIG. 2 shows a male object that fastens to the female object using a Ball and Detent design.

FIG. 3 shows a female object of a Ball and Detent design and details components.

FIG. 4 shows a male object of a Ball and Detent design and details components.

FIG. 5 shows a female object with springs and bars.

FIG. 6 shows a male object and details components.

FIG. 7 shows a female object with spring and grooves.

FIG. 8 shows a male object with grooves.

FIG. 9 shows a female object with wings.

FIG. 10 shows a cross-section of a female object with wings.

FIG. 11 shows a male object with ability to store potential energy.

FIG. 12 shows a diagram of a male object with substrate and attacher, it also shows a female object with substrate and attacher, these are attached where the male attacher and female attacher join. The objects having information components.

FIG. 13 shows a male object that fastens to the female object using a Ball and Detent design. The female object having an information component.

FIG. 14 shows a female object of a Ball and Detent design. The female object having an electrical contact.

FIG. 15 shows a male object of a Ball and Detent design. The male object having an electrical contact.

FIG. 16 shows a female object with springs and bars. The female object having a switch.

FIG. 17 shows a male object and details components. The male object having an indicator.

FIG. 18 shows a female object with spring and grooves. The female object having a reader.

FIG. 19 shows a male object with grooves. The male object having an identification component.

FIG. 20 shows a female object with wings. The female object having a sensor.

FIG. 21 shows a male object with stored potential energy. The male object having a sensed feature.

FIG. 22 shows a mobile object with at least one female component.

FIG. 23 shows a mobile object with at least one female component and a handle, said handle associated with at least one male component.

FIG. 24 shows a mobile object with at least one female component and a strap, said strap associated with at least one male component.

FIG. 25 shows a mobile object with at least one female component and an accessory, said accessory associated with at least one male component.

FIG. 26 shows a mobile object with at least one female component and a mobile phone, said mobile phone associated with at least one male component.

FIG. 27 shows a mobile object with at least one female component and keys, said keys associated with at least one male component.

FIG. 28 shows a mobile object with an embedded antenna.

FIG. 29 shows a mobile object with an embedded antenna, a battery, and a transmitter.

FIG. 30 shows a mobile object with a battery, a transmitter, and wires associated with at least one female component.

FIG. 31 shows a mobile object with an antenna, a battery, and a storage device.

FIG. 32 shows a bag with a storage device, battery, and wires associated with at least one female object.

FIG. 33 shows a mobile object with a processor, battery, and reader.

FIG. 34 shows a mobile object with a processor, battery, and wires associated with at least one male object.

FIG. 35 shows a mobile object with a battery, antenna, and transceiver.

FIG. 36 shows a mobile object with a battery, transceiver, and wires associated with at least one female object.

FIG. 37 shows a bag with a fuel cell, antenna, and transmitter.

### DETAILED DESCRIPTION OF THE INVENTION

To define the fastener of invention, at least a one-step motion for male object and female object connection through the motion of the male object to affix to the female object including but not limited to, rotational, translational, rolling, button upwards/downwards push, or de/compressing a spring. The male object deconnects from the female object where at least a one-step motion for male object and female object connection through the motion of the male object to de-affix to the female object including but not limited to, rotational, translational, rolling, button upwards/downwards push, or de/compressing a spring. The male object is composed of an attacher as the said attacher is load bearing. As the attacher is a component of the male object that affixes to the female component. While, the male object may also comprise of two parts, the attacher and the substrate. The substrate is a part that is load bearing and separate from the attacher as it does affix to the female component. The female object comprises at least one substrate. Said female part also comprises at least one attacher and at least one substrate. The male object and female object when fastened serve both to fasten or affix two objects together and provides information of the connection. As the male object and female object when unfastened serves both to remove the mechanical fastening or affixing and provides information of the connection using an external component, which include but not limited to a sensor, MEMs, microphone, visual, and mechanical. Said information of the connection is electrical, magnetic, electromagnetic, optical, mechanical,and sound/pressure, clicks, vibrations, shocks, or a combination thereof. The male object and female object when fastened serve both to fasten or affix two objects together, as load bearing, and to provide information of the connection. Said information of the connection is electrical, magnetic, electromagnetic, optical, and sound/pressure. The said fastener of invention range of length and width of the male object is between 3 mm and 10 mm, between 10 mm and 50 mm, and greater than 50 mm. The said fastener of invention range of thickness of the male object is between 0.5 mm and 3 mm, between 3 mm and 10 mm, between 10 mm and 50 mm, and greater than 50 mm. The said fastener of invention ratio of length to thickness of the male object is between 0.5 and 1, 1 and 2, 2 and 5, 5 and 50, and greater than 50. There are a list of embodiments of the male object and female object components. While, the said fastener of invention range of length and width of the female object is between 3 mm and 10 mm, between 10 mm and 50 mm, and greater than 50 mm. The said fastener of invention range of thickness of the female object is between 0.5 mm and 3 mm, between 3 mm and 10 mm, between 10 mm and 50 mm, and greater than 50 mm. The said fastener of invention ratio of length to thickness of the female object is between 0.5 and 1, 1 and 2, 2 and 5, 5 and 50, and greater than 50. The force required to insert the male to the female component or vice versa is defined to be the insertion force. The insertion force can range between −5 and 0 lbs, 0 and 0.1 lbs, 0.1 and 1 lbs, 1 and 5 lbs, 5 and 15 lbs, 15 and 50 lbs, 50 and 150 lbs, and greater than 150 lbs. And, where the said fastener of invention torque required to twist the male relative to the female or vice versa can be between 0 and 0.001 lb-in, 0.001 and 0.1 lb-in, 0.1 and 1 lb-in, 1 and 10 lb-in, 10 and 100 lb-in, 100 and 10000 lb-in, and greater than 10000 lb-in. The force required to remove the male from the female or vice versa may be between −50 and 0 lbs, 0 and 0.01 lbs, 0.01 and 1 lbs, 1 lbs and 5 lbs, 5 lbs and 50 lbs, and greater than 50 lbs. The holding force of the assembly may be between 0 and 0.01 lbs, 0.01 and 1 lbs, 1 lbs and 5 lbs, 5 lbs and 50 lbs, 50 lbs and 500 lbs, 500 lbs and 10000 lbs, and greater than 10000 lbs. There are a list of embodiments of the male object and female object components.

The male object attacher embodiment comprises of at least one of a spring, flap, bolt, wire, non-stick adhesive, magnet, or related device. As a male object attacher embodiment which may comprise of at least one attacher part joining the substrate. As yet another male object attacher embodiment of which may comprise of at least one attacher part affixing to the female object. As yet another male object attacher embodiment of which may comprise of at least one joining the substrate. As yet another male object attacher embodiment the material comprises of but not limited to a polymer, metal, metal alloy, spring steel, glasses, machined parts, sintered devices, nanostructured materials, microstructured materials resins, metal oxide, ceramics or combination thereof. As yet another male object attacher embodiment has coatings or treatments including oxide, anodize, paint, passivation, glass, crystal, thin films, and optically active coatings. As yet another male object attacher embodiment made of one or more said materials. As yet another male object attacher embodiment made of one or more colors. As another male object attacher embodiment, the spring, flap, bolt, wire, non-stick adhesive can be of different shapes including but limited to a coil, cylinder, and thin film. As yet another male object attacher embodiment can be extruded from the substrate, attached to the substrate by adhesive, button, bolt, bar, extruded part to attach to the substrate, and wrapped around the substrate. As yet another male object attacher embodiment, is a mechanical connector to the female and electrical connector. The said electrical connection is made by the attacher being an electrode. The electrode has contact with an electronic component by means of electrical wire and direct. Said electrical component comprises of but is not limited to an ASIC, FPGA, Wireless Chip, Bluetooth, NFC, UWB, zigbee, electromagnetic, Red Tacton, NFMI, WWAN, WLAN, acoustic transceiver, Processor, sensor, MEMs, LCD, OLED, LED display, e-ink, LED, RFID chip. The electrical component embodiment measures electrical resistance, resistivity, conductance, current, capacitance, impedance, shorting of the female object electrode circuit, inductance, and changes thereof. As yet another male object attacher embodiment is to affix to one or more female objects. As yet another male object attacher embodiment the male object attacher affixes to at least one female attacher. As yet another male object attacher embodiment can have but not limited to a color, design, schemes, logo made from metal, paper, ink to enhance functionality and/or aesthetic appeal. As yet another male object attacher embodiment of which these are one or more electrodes. As yet another male object attacher embodiment one or more electronics components connect to the attacher.

The male object substrate is made of different shapes and sizes to both be aesthetically pleasing and load bearing. As a male object substrate embodiment of which can comprise of a single or combination of colors. As yet another male object substrate is a button, bolt, bar, extruded part to directly affix the female object. As yet another male object substrate can be extruded from the substrate, attached to the male substrate by adhesive, button, bolt, bar, extruded part. The button, bar, and extruded part can serve as a conductor. As yet another male object substrate embodiment the material comprises of but not limited to a polymer, metal, metal alloy, spring steel, glasses, machined parts, sintered devices, nanostructured materials, microstructured materials resins, metal oxide, ceramics or combination thereof. As yet another male object substrate embodiment has coatings or treatments including oxide, anodize, paint, passivation, glass, crystal, thin films, and optically active coatings. As yet another male object substrate embodiment where it is inked, painted, and textured. As yet another male object substrate embodiment is having a placed electrode affixed directly by contact to the female part electrode. The said electrode is in contact with the male object attacher, where the male object attacher is a conductor. The said electrode is in contact with electronic components attached to it including but not limited to an LCD, OLED, LED display, e-ink, LED, RFID, Load sensor, MEMs, transducer, ASIC, FPGA, Wireless Chip, and Processor. The said electrode is in contact with a wire that is in contact with electronic components including but not limited to a LCD, OLED, LED display, e-ink, LED, RFID, Load sensor, MEMs, transducer, ASIC, FPGA, Wireless Chip, and Processor. The information recorded by the electronic components including but limited to authorization, identification, usage, load weight, and product type. One or more electronic components have capability to communicate with other sensors, chips, and electrical components in proximity. The electronic components have the capability to communicate with other sensors, chips, and electrical components to an interrogator. The said electrical components are active powered by at least one battery, fuel cell, energy harvester, and electrical source. The communication of said electrical components is passive and interrogator is active. The said electrical components is powered by wireless energy. The said electrical components are powered by an electrical outlet. The said interrogator can comprise a mobile device, RFID reader, wireless/microwave, Bluetooth, NFC, UWB, zigbee, electromagnetic, Red Tacton, NFMI, WWAN, WLAN, radar, and optical scanner. As yet another male object substrate embodiment two or more components where the electronic components are placed in the housing of the substrates. As yet another male object substrate embodiment injection molding, 3D-printing, mechanical cutting the part, and auto-coiling. As yet another embodiment of the substrate, the materials can be of one or more: polymers, metals, metal oxides, ceramics or combination thereof. As yet another male object substrate embodiment of which may contain one or combinations of shapes that are but not limited to holes, chamfers, grooves, fillets, bevels, and extrusions. As yet another male object substrate embodiment, fabrication is achieved using injection molding, 3D-printing, mechanical cutting the part, or a combination thereof. As yet another male object substrate embodiment can have but not limited to a color, design, schemes, logo made from metal, paper, ink to enhance functionality and/or aesthetic appeal. As yet another male object substrate embodiment is made of different materials. The male object substrate can comprise of many adjoined together.

The female object attacher embodiment comprises of at least one of a spring, flap, bolt, wire, non-stick adhesive, magnet, or related device. As a female object attacher embodiment can be extruded from the substrate, attached to the female substrate by adhesive, button, bolt, bar, extruded part. As yet another female object attacher embodiment of which may comprise of at least one attacher part affixing to the male object. As yet another female object attacher embodiment of which may comprise of at least one joining the substrate. As yet another female object attacher embodiment the material comprises of but not limited to a polymer, metal, metal alloy, spring steel, glasses, machined parts, sintered devices, nanostructured materials, microstructured materials resins, metal oxide, ceramics or combination thereof. As yet another female object attacher embodiment has coatings or treatments including oxide, anodize, paint, passivation, glass, crystal, thin films, and optically active coatings. As yet another female object attacher embodiment made of one or more said materials. As yet another female object attacher embodiment made of one or more colors. As another female object attacher embodiment, the spring, flap, bolt, wire, non-stick adhesive can be of different shapes including but limited to a coil, cylinder, and thin film. As yet another female object attacher embodiment can be extruded from the substrate, attached to the substrate by adhesive, button, bolt, bar, extruded part to attach to the substrate, and wrapped around the substrate. As yet another female object attacher embodiment, is a mechanical connector to the female and electrical connector. The said electrical connection is made by the attacher being an electrode. The electrode has contact with an electronic component by means of electrical wire and direct. Said electrical component comprises of but is not limited to an ASIC, FPGA, Wireless Chip, Processor, sensor, MEMs, LCD, OLED, LED display, e-ink, LED, RFID chip. The electrical component embodiment measures electrical resistance, resistivity, conductance, impedance, capacitance, current, shorting of the male object electrode circuit, inductance, and changes thereof. As yet another female object attacher embodiment is to affix to one or more female objects. As yet another female object attacher embodiment the female object attacher affixes to at least one female attacher. As yet another male object attacher embodiment of which these are one or more electrodes. As yet another female object attacher embodiment one or more electronics components connect to the attacher. As yet another female object attacher embodiment can have but not limited to a color, design, schemes, logo made from metal, paper, ink to enhance functionality and/or aesthetic appeal.

The female object substrate is made of different shapes and sizes to both be aesthetically pleasing and load bearing. As a female object substrate embodiment of which can comprise of a single or combination of colors. As yet another female object substrate is a button, bolt, bar, extruded part to directly affix the female object. As yet another male object substrate can be extruded from the substrate, attached to the female substrate by adhesive, button, bolt, bar, extruded part. The button, bar, and extruded part can serve as a conductor. As yet another female object substrate embodiment the material comprises of but not limited to a polymer, metal, metal alloy, spring steel, glasses, machined parts, sintered devices, nanostructured materials, microstructured materials resins, metal oxide, ceramics or combination thereof. As yet another female object substrate embodiment has coatings or treatments including oxide, anodize, paint, passivation, glass, crystal, thin films, and optically active coatings. As yet another female object substrate embodiment where it is inked, painted, and textured. As yet another male object substrate embodiment is having a placed electrode affixed directly by contact to the female part electrode. The said electrode is in contact with the male object attacher, where the female object attacher is a conductor. The said electrode is in contact with electronic components attached to it including but not limited to an LCD, OLED, LED, e-ink, display, LED, RFID, Load sensor, MEMs, transducer, ASIC, FPGA, Wireless Chip, and Processor. The said electrode is in contact with a wire that is in contact with electronic components including but not limited to a LCD, OLED, LED display, e-ink, LED, RFID, Load sensor, MEMs, transducer, ASIC, FPGA, Wireless Chip, and Processor. The information recorded by the electronic components including but limited to authorization, identification, usage, load weight, and product type. One or more electronic components have capability to communicate with other sensors, chips, and electrical components in proximity. The electronic components have capability to communicate with other sensors, chips, and electrical components to an interrogator. The said electrical components are active powered by at least one battery, fuel cell, energy harvester. The communication of said electrical components is passive and interrogator is active. The said electrical components are powered by wireless energy. The said electrical components are powered by an electrical outlet. The said interrogator can comprise a mobile device, RFID reader, Bluetooth, NFC, UWB, zigbee, electromagnetic, Red Tacton, NFMI, WWAN, WLAN, wireless/microwave, radar, and optical scanner. As yet another female object substrate embodiment two or more components where the electronic components are placed in the housing of the substrates. As yet another female object substrate embodiment further embodiment has an optical window. As yet another female object substrate embodiment injection molding, 3D-printing, mechanical cutting the part, and auto-coiling. As yet another embodiment of the female substrate, the materials can be of one or more: polymers, metals, metal oxides, ceramics or combination thereof. As yet another female object substrate embodiment of which may contain one or combinations of shapes that are but not limited to holes, chamfers, grooves, fillets, bevels, and extrusions. As yet another female object substrate embodiment, fabrication is achieved using injection molding, 3D-printing, mechanical cutting the part, or a combination thereof. As yet another female object substrate embodiment can have but not limited to a color, design, schemes, logo made from metal, paper, ink to enhance functionality and/or aesthetic appeal. As yet another female object substrate embodiment is made of different materials. The female object substrate can comprise of many adjoined together.

The male object and female object may include accessory parts. The male object and female object has at least one plunger affixed to the attacher. The plunger serves to protect the attacher. The said plunger as an embodiment is a conductor. The male object and female object can contain a stopper affixed to the attacher. This serves a purpose to connect the male or female object attacher to the male or female object substrate respectively. The male object and female object can contain a guide feature affixed to the substrate. The guide feature serves the purpose of helping the user know how to insert the male object, as this includes but not limited to, performing the motion of at least one rotation, translation, rolling, button upwards/downwards push, or de/compressing a spring, or any related motion. The male object and/or female object substrate may be added load bearing support using a support beam, bar, cylinder, or irregular shape. The substrate support beam, or bar or any shape to provide load bearing to the male object and/or female object.

The said fasteners have application as providing utility to one or more objects. The said fastener, male and/or female components may be attached to or associated with items that include, but are not limited to, walls, accessories, cars, dashboards, tables, bags, clothing, athletic gear, electronics, phones, tablets, swartwatches, wearables, musical instruments, bicycles, pictures, televisions, speakers, tools, appliances, luggage, cookware, linens, lighting, machinery, food storage, and boards. The said fastener provides aesthetic and mechanical support. The said fastener may provide one or more of aesthetic, mechanical, load bearing, and information about the fastening or affixing. This information can be in the form including, but not limited to, electrical, visual, magnetic, electromagnetic, mechanical, sound, shock, and vibration. The fastener information as an embodiment of at least one strap is joined, an electronic device specialized fastener is closed, or the fastener is unjoined or un-affixed.

As an embodiment, the male object of the fastener can be part of or placed in accessory objects including but not limited to walls, accessories, cars, dashboards, tables, bags, clothing, athletic gear, electronics, phones, tablets, swartwatches, wearables, musical instruments, bicycles, pictures, televisions, speakers, tools, appliances, luggage, cookware, linens, lighting, machinery, food storage, and boards. The said accessory objects may have between 0 and 1 female assembly, between 1 and 5 female assemblies, between 5 and 10 female assemblies, or more than 10 female assemblies. Accessories may have between 0 and 1 male assembly, between 1 and 5 male assemblies, between 5 and 10 male assemblies, or more than 10 male assemblies. As another embodiment, the male object of the fastener can be placed on components of the said objects including but not limited to flaps, shoulder straps, gussets, and straps as part of the objects that are but not limited to walls, accessories, cars, dashboards, tables, bags, clothing, athletic gear, electronics, phones, tablets, swartwatches, wearables, musical instruments, bicycles, pictures, televisions, speakers, tools, appliances, luggage, cookware, linens, lighting, machinery, food storage, and boards. The said fastener with electronic components is able to sense and store information that can be read by an interrogator and reader. The interrogator and reader can include but not limited to an RFID reader/interrogator, Bluetooth, NFC, UWB, zigbee, electromagnetic, Red Tacton, NFMI, WWAN, WLAN, Optical reader/interrogator, Smartphone/Cell Phone reader/interrogator, and Antenna reader/interrogator in the microwave, infrared radiowave, and optical spectra. As an embodiment of the fastener information it is powered by a wire or wirelessly from the said objects including but not limited to bag, luggage, box, garments, clothing, and shoes. The said objects including but not limited to walls, accessories, cars, dashboards, tables, bags, clothing, athletic gear, electronics, phones, tablets, swartwatches, wearables, musical instruments, bicycles, pictures, televisions, speakers, tools, appliances, luggage, cookware, linens, lighting, machinery, food storage, and boards have the embodiment of having at least one battery, fuel cell, energy harvester and wire and/or wireless transmission to power the fastener said information. The wireless transmission that includes but not limited to a rectenna, mobile device, or wall socket.

The said accessory object embodiment is having a processor, storage, integrated circuit which connects between electrical power and at least one battery, fuel cell, energy harvester. Another said accessory object embodiment is having a processor, storage, integrated circuit which connects between electrical power and at least one battery, fuel cell, energy harvester and connecting to the fastener attached electronic components. Yet another said accessory object embodiment is having a processor, storage, integrated circuit which connects between electrical power and at least one battery, fuel cell, energy harvester and connecting to the fastener electrodes to gather information. With the said fasteners with electronic capability joining, this causes information transfer to power a display, e-ink, one or more LED's, OLED, LCD, Quantum Dot, phosphors to illuminate and show the object is closed. The said accessory object as an embodiment has an electrical wiring with contact to at least one electrical component. The said accessory object as an embodiment has an optical wiring in contact to at least one electrical component. The electrical components include but are not limited to an electrical storage device, processor, interrogator, reader, and cell phone. As an embodiment of the said accessory object with said fasteners, an external electrical device in the said object include but are not limited to a bag, luggage, box, garments, clothing, and shoes is powered by at least one battery, fuel cell, energy harvester where the electrical storage device is embedded in the bag. The said fastener electronics may communicate with said objects in the bag. This can include but not limited to proximity of objects, pressure, touch, proximity, electrical contact or related sensing. The said fasteners can communicate with each other wirelessly. The said fasteners can communicate with each other through electrical contact. As an embodiment, this wireless power originates by an electrical wire connection, grid connection, or wireless.

At least one said fastener is used in a bag made of materials of leather, fabric, polymer, metal, ceramic, or related material. The said bag may have lengths between 2 in and 5 in, 5 in and 10 in, 10 in and 25 in, 25 in and 50 in, and greater than 50 in. The bag may have widths between 0.125 in and 1 in, between 2 in and 5 in, 5 in and 10 in, 10 in and 25 in, 25 in and 50 in, and greater than 50 in. The bag may have height between 2 in and 5 in, 5 in and 10 in, 10 in and 25 in, 25 in and 50 in, and greater than 50 in. The bag may have between 0 and 1 female assembly, between 1 and 5 female assemblies, between 5 and 10 female assemblies, or more than 10 female assemblies. The bag may have between 0 and 1 male assembly, between 1 and 5 male assemblies, between 5 and 10 male assemblies, or more than 10 male assemblies. The said bag that is made of at least one color, have design, scheme, or related visual. The color can include fluorescence. The said bag is of at least one said female object where said male object attaches an accessory object attached to a said male object to the said bag. The said bag has an embedded said wireless reader. The said wireless reader is an interrogator and reader can include but not limited to an RFID reader/interrogator, Optical reader/interrogator, Bluetooth, NFC, UWB, zigbee, electromagnetic, Red Tacton, NFMI, WWAN, WLAN, Smartphone/Cell Phone reader/interrogator, and Antenna reader/interrogator in the microwave, infrared radiowave, and optical spectra. The male fastener has an attachment for a said utility accessory object including but not limited to keys, wallet, and cell phone for but not limited to a button, wire, magnetic, or related. The said bag embodiment electronic components are able to communicate with other wireless readers and interrogators. The said reader is an interrogator and reader can include but not limited to an RFID reader/interrogator, Optical reader/interrogator, Smartphone/Cell Phone reader/interrogator, and Antenna reader/interrogator in the microwave, infrared radiowave, and optical spectra. The said bag information from said fasteners information can be read and processed by a computer to synthesize and analyze the data. The said bag with at least one said fastener can interrogate objects placed in the bag by means of RFID, Wireless chip, optical, radiowaves, and infrared. The said bag with at least one said fastener can interrogate utility objects placed in the bag by means of RFID, Wireless chip, optical, radiowaves, and infrared. The said bag with at least one said fastener can interrogate objects placed in the bag by means of RFID, Wireless chip, Bluetooth, NFC, UWB, zigbee, electromagnetic, Red Tacton, NFMI, WWAN, WLAN, optical, radiowaves, and infrared when attached to a said fastener. The said bag can interrogate objects placed in the bag by means of RFID, Wireless chip, optical, radiowaves, and infrared without at least one fastener. A wall outlet can wirelessly power the said fastener electronics.

The said fastener works as a button, attached to a zipper, attached to one or more straps, or to the clothing itself, helmet, shoe snap, pants buckle. The said fastener attached is at least one female object only. The said fastener attached to the clothing is at least one male object and at least one female object. The said fastener can contain electronics. These electronics are resistance of a washing machine and drier, in that liquids do not harm the electronics. The said fastener can contain electronics is encapsulated by a transparent, semi-transparent, opaque housing or a combination thereof. As an embodiment the said fastener can be packaged in a housing. The said housing is encapsulated by a transparent, semi-transparent, opaque housing or a combination thereof. The said fastener can have electronic components that offer the fastener electronic capability to send information about the clothing. In one said fastener embodiment the electronics is an RFID that is passive, active, or reprogrammable. In another said fastener embodiment the electronics is an RFID that is passive, active, or reprogrammable. In yet another said fastener embodiment the electronics is wifi chip, electrical connection to a wifi chip, and optical transmission. The optical read out can be quantum dots, OLED's, LCD, and e-ink patterns information, laser transmission. The said fastener transmission can be a camera. The said electronics are a thin film, bulk in shape, flexible, wrap around the fasteners, adhesively in contact to the fastener.

In further use, the said fastener at least one female object is a wall hanging device, at least one rack. The male object is part of the hanger or attached to a fastening to the female object. The said hanging device, at least one hanger. The said hanging device is electrical powered to the grid, wirelessly, and by mechanical force. The said hanging device may have load sensors to determine the weight of clothing and takes into account the weight of the hanger. The hanging device sensors include but are not limited to pressure, touch, proximity, electrical contact, and related methods. The said hanging device can communicate with the clothing. This may be wirelessly, grid energy, optical transfer, pressure, sound, visual, and magnetic. At least one or more electronics are embedded in the said hanger.

A locking and/or unlocking mechanism wirelessly, by mechanical switch, electrical switch, optical switch, that causes mechanical affixing of the fastener male objects to the female objects. As a fastening locking and/or unlocking embodiment, this includes for each said utility objects and accessory objects includes but not limited to keys, wallet, and cell phone. This fastening including but not limited to, at least one rotational, translational, rolling, button upwards/downwards push, or de/compressing a spring where the attacher locks to the female object. As an embodiment, the female object attacher can be then motioned to lock the male object. The design of the fastener is specific to the utility objects and accessory objects to fasten that are but not limited to holes, chamfers, grooves, fillets, bevels, and extrusions. As a fastening locking and/or unlocking embodiment the male and female object are affixed autonomously by wireless communication using an electrical motor and electrical-mechanical actuator. The said autonomous locking and/or unlocking receives feedback about the lock. The said fasteners information can be recorded by an electronic device receiving sensory information feedback to the male and female object affixing, as well as, connection of fastener to utility objects including but not limited to keys, wallet, and cell phone. The said objects can be controlled by motion to affix to the said connector using the rotational, translational, de/compression as a button switch to provide a switch for on-off connection. The said wireless electromagnetic transfer is by a remote interrogator. This said interrogator can be of the following but not limited to RFID reader/interrogator, Bluetooth, NFC, UWB, zigbee, electromagnetic, Red Tacton, NFMI, WWAN, WLAN, Optical reader/interrogator, Smartphone/Cell Phone reader/interrogator, and Antenna reader/interrogator in the microwave, infrared radiowave, and optical spectra. The signal can be of pulse width modulation, frequency domain, phase domain, amplitude, or a combination thereof. The said fastener locks by remote sensing is locked by an electrical motor, electrical switch, or electrical actuator, to position the male object to the female object. The said locking and/or unlocking as another embodiment is a fastener where at least one female object is attached to walls, accessories, cars, dashboards, tables, bags, clothing, athletic gear, electronics, phones, tablets, swartwatches, wearables, musical instruments, bicycles, pictures, televisions, speakers, tools, appliances, luggage, cookware, linens, lighting, machinery, food storage, and boards. The said locking and/or unlocking as another embodiment is a fastener where at least one female object and one male object is attached to walls, accessories, cars, dashboards, tables, bags, clothing, athletic gear, electronics, phones, tablets, swartwatches, wearables, musical instruments, bicycles, pictures, televisions, speakers, tools, appliances, luggage, cookware, linens, lighting, machinery, food storage, and boards.

Thus the present inventions relate to methods, apparatus and systems for fastening, connecting, or affixing objects and communicating information in predetermined systems. They further relate to systems and assemblies incorporating fasteners of novel description.

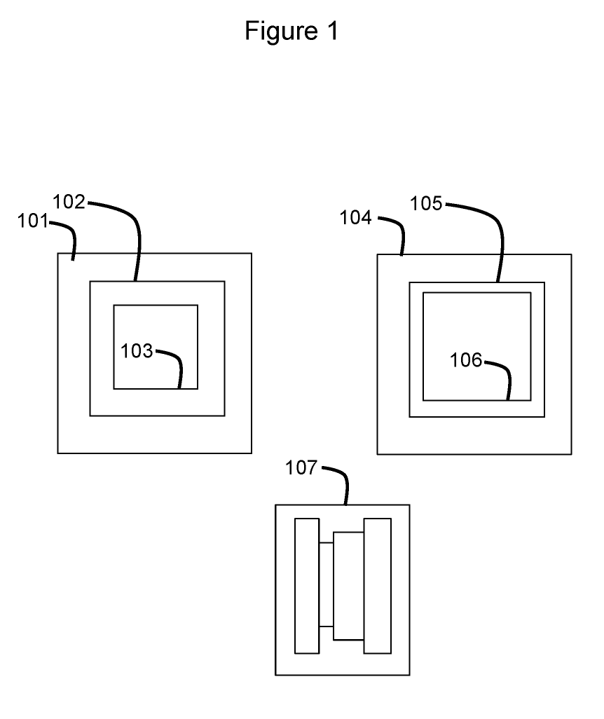

Turning to FIG. 1. FIG. 1 shows a male object 101 comprising a substrate 102 and an attacher 103. Further shown is a female object 104 comprising a substrate 105 and an attacher 106. 101 and 102 can be connected together mechanically to form a connected assembly 107.

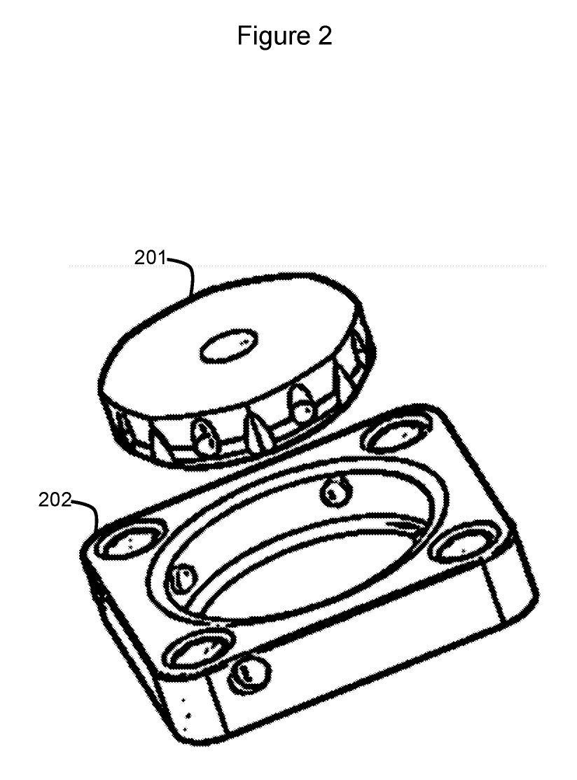

FIG. 2 shows a male object 201 and a female object 202, showing a male object that fastens to the female object using a Ball and Detent design. The male object has grooves and chamfer that fit into the cylindrical pocket of the female object. This works when the male object is placed in the female object, the female attacher springs are compressed, the male object in the enter/exist groove is then rotated where the male object and female attacher spring fits into the second retaining groove and decompresses locking the male object to the female object. Alternatively, the male is inserted into the female in an aligned or misaligned orientation such that the insertion chamfer compresses the plungers/spring until the retaining groove is encountered at which point the plunger and spring extends into the groove to secure the device rotationally, axially, and translationally. To unlock the male object is pushed up to female object, and rotated where the male object and female attacher spring is in the exit groove.

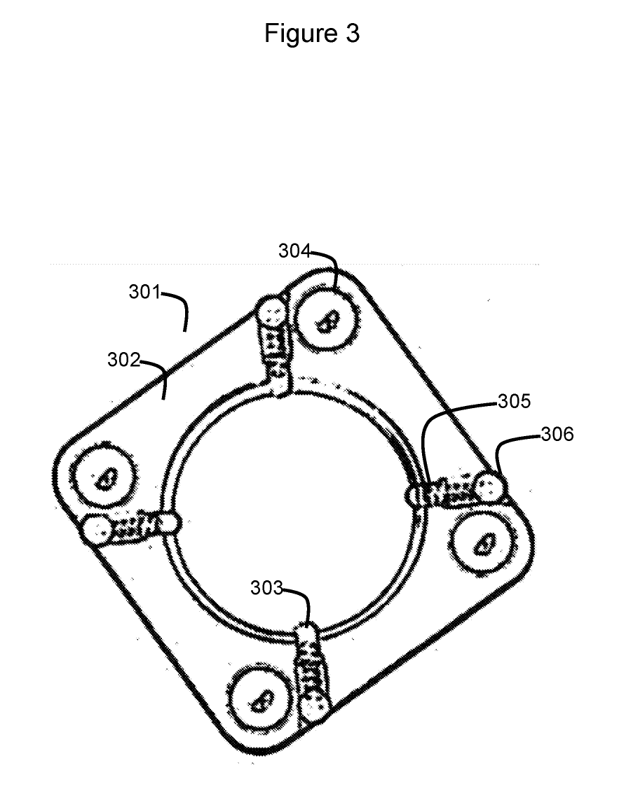

FIG. 3 shows the female object where the substrate 301 holds the load bearing, the attacher 302 is sandwiched in the substrate attached to the plungers 303. The plunger as seen is compressed by the male object when the male object is placed in the female object. The stopper 306 attaches to the spring 305 with is attached to the plunger 303. Fasteners 304 attach the attacher to the substrate.

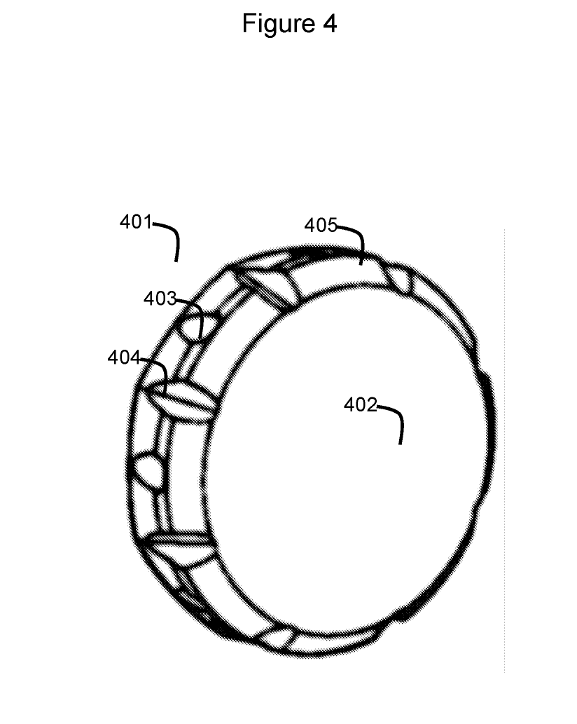

FIG. 4 shows a male object, the attacher 402, attached to substrate 401. The male object comprises one or a plurality of retaining grooves 403, zero, one, or a plurality of exit grooves 404, and an insertion chamfer 405.

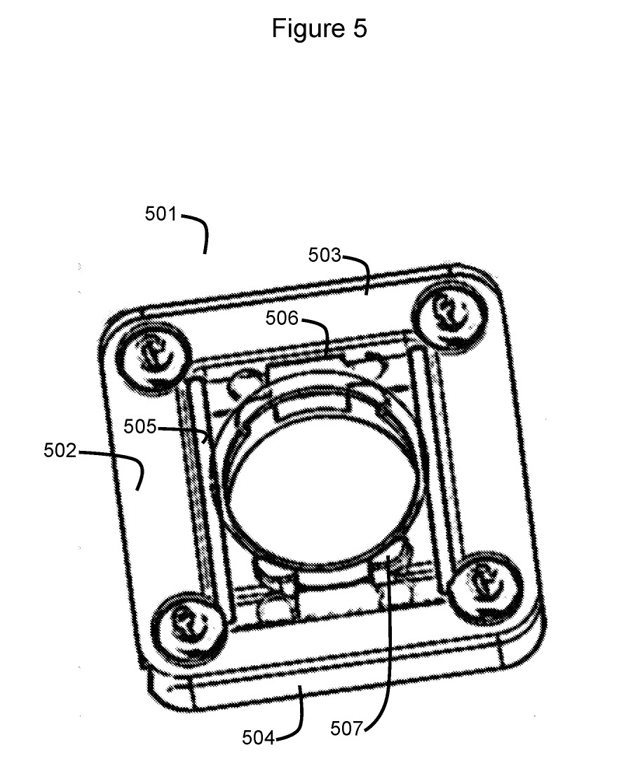

FIG. 5 shows a female object associated with a substrate 501 comprising an attacher 503, coverplate 502, retaining bar 505, spring 506, base 504, and retaining bar limiter 507. The male object is inserted into the female object and may or may not be rotated to lock into place as a retaining bar limiter behave like flaps. When inserted, the male and female objects are rotationally, axially, and translationally coupled. The springs 506 apply a predetermined force to the retaining bars 505. This force is chosen to optimize holding force, torque required for removal, and insertion force.

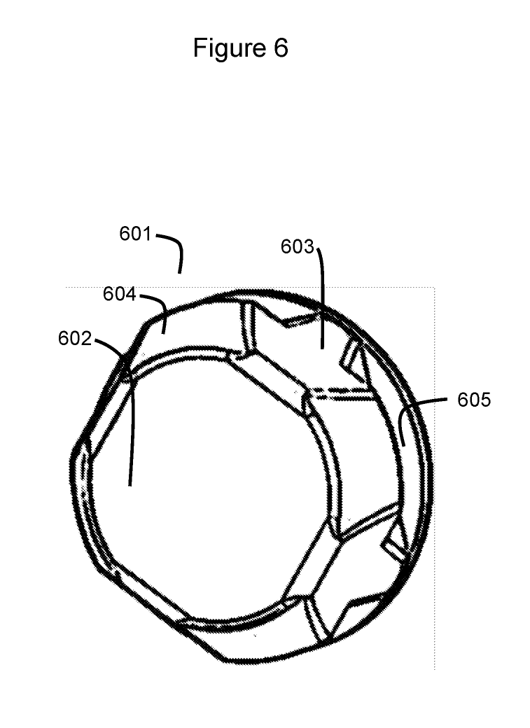

FIG. 6 shows a male component associated with a substrate 601. The component comprising an attacher 602, an insertion chamfer 604, an exit chamfer 603, and a retaining groove 605. The insertion is such that the insertion chamfers contact the retaining bars and tension the springs. Upon full insertion the retaining bar engages with the retaining groove. To remove, the male and female are rotated relative to each other by somewhere between 25 and 335 degrees in order for the exit chamfer to be engaged. The exit chamfer may also serve to provide a ‘kick-out’ force when engaged by the retaining bar.

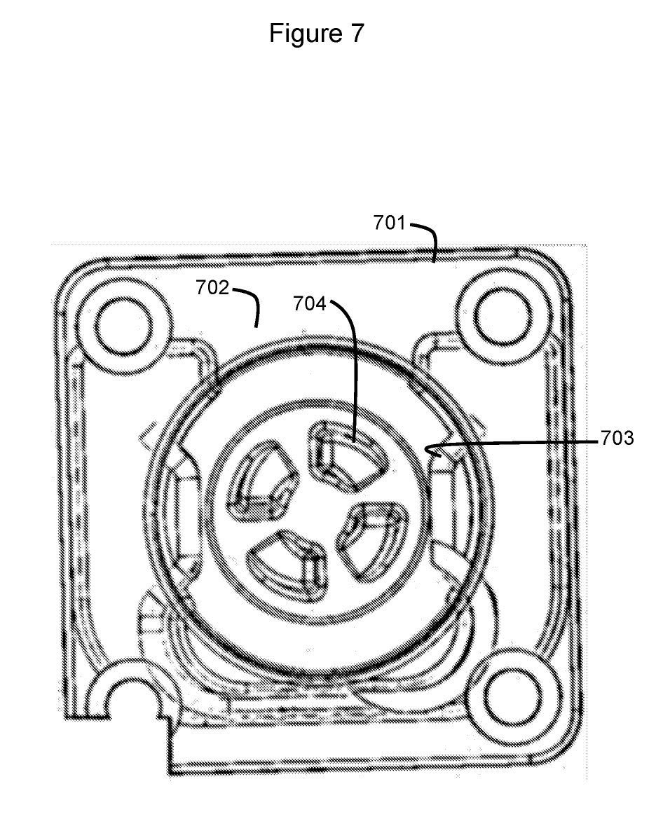

FIG. 7 shows a female component comprising an attacher 701, coverplate 702, guide feature 704, and spring clip 703.

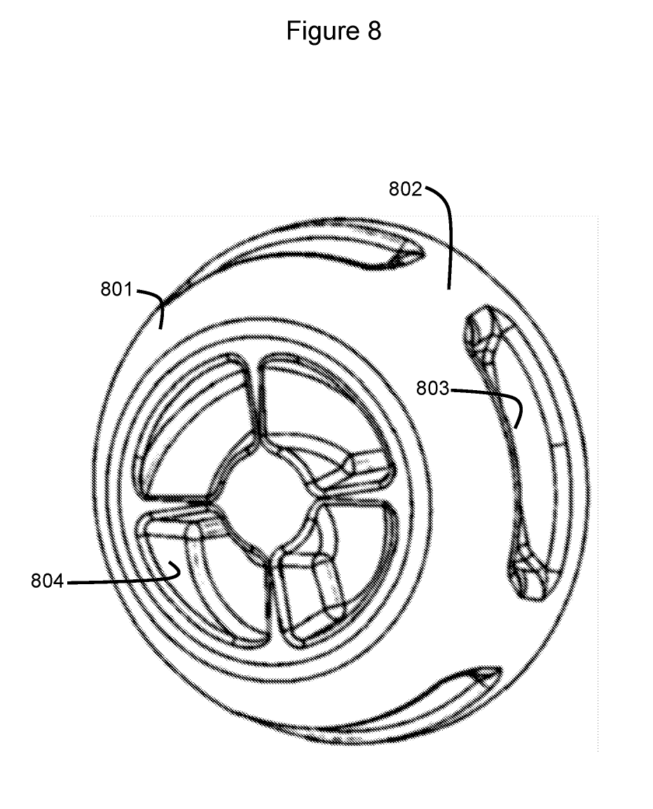

FIG. 8 shows a male component comprising an attacher 802, insertion fillet 801, retaining groove 803, and guide groove 804. The male and female components engage such that upon axial insertion the spring clip is extended by the insertion fillet. Upon alignment of the retaining groove to the spring clip feature, the spring clip engages with the retaining groove locking the male and female components together. The guide grooves engage with the guide features to limit the orientation of insertion and removal. They further interact to translate rotational motion to axial motion upon removal, which is obtained by rotating the male and female with respect to each other. Thus, insertion may occur by a combination of axial, rotational, etc. motion and removal may occur by a combination of axial, rotational, etc. motion.

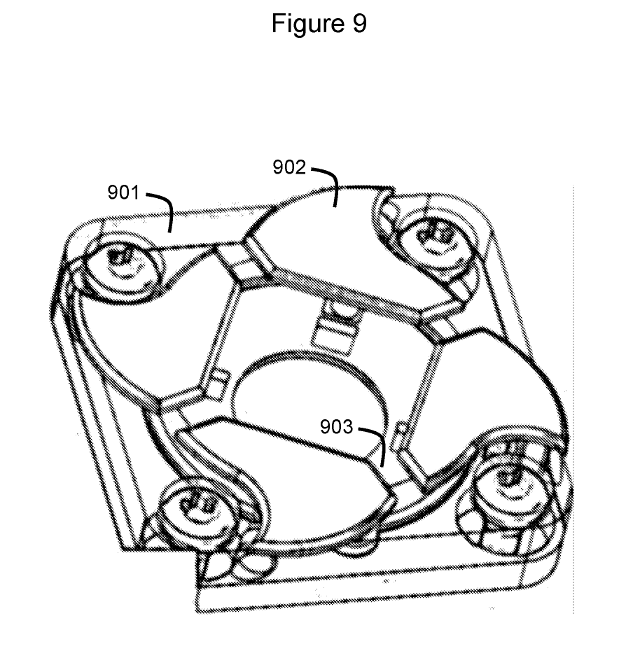

FIG. 9 shows a female component comprising an attacher 901, wing 802, and lock plate 903. The components are engaged with axial motion. The insertion chamfer on the male component engages with the wings on the female component, inducing the wings to radially retract and compress a spring. Upon insertion the wing engages with the retaining groove to hold the components in place relative to each other. Rotation without axial force will not disengage the wings from the retaining groove. Axial motion against the spring-loaded locking plate is required to disengage the locking groove from the locking plunger such that rotation can induce radial retraction of the wings. Upon removal of the male component, the device may be ‘preloaded’ such that the wings are in the retracted position with stored energy in the form of the spring. Upon insertion of the male which compresses the locking plate, the locking groove disengages and the wings spring radially inward.

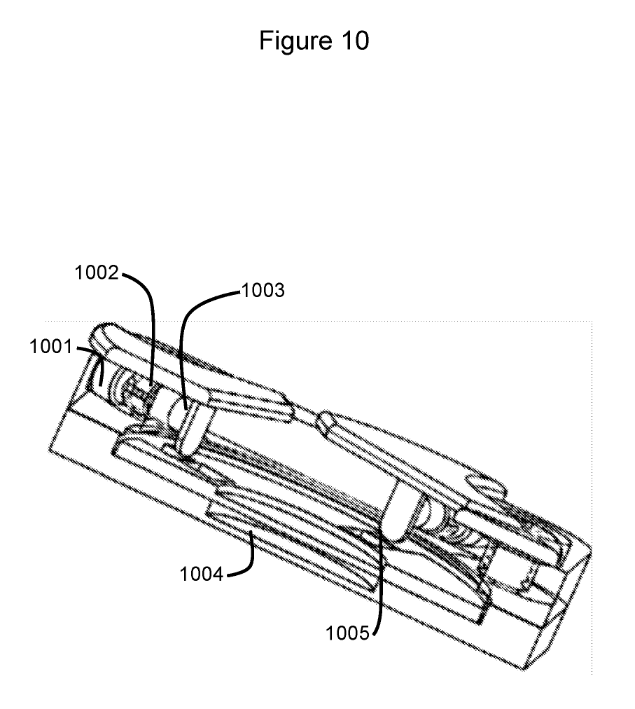

FIG. 10 shows a cross-section of FIG. 9 comprising a stopper 1001, spring 1002, plunger 1003, spring 1004, and locking groove 1005.

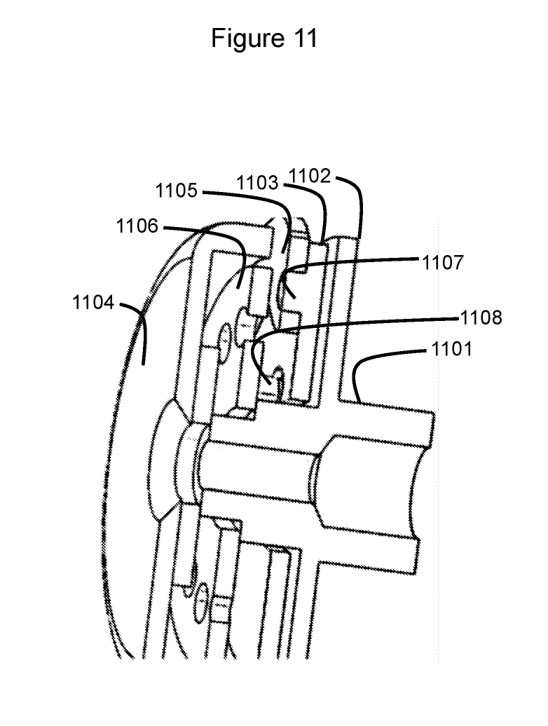

FIG. 11 shows a male component 1101. The component is shown in the ‘unloaded position’. The spring 1105 is connected to the base plate 1103 by the spring pin 1107, and to the spin wheel 1106 by a pin 1108. The face plate 1104 and plunger 1101 are coupled together. Upon rotation of the plunger with respect to the base plate, the spring is contracted as the two pins move relative to each other. The wheel pin, which engages with the base plate, rotates until it encounters a locking feature on the base plate upon which the device is rotationally rigid, and the spring preloaded such that the spring diameter is equal or less than the plunger diameter. Upon insertion into a female component, the plunger moves axially relative to the base plate, which disengages the wheel pin from the base plate and allows for free rotation. The stored energy of the spring is released, and the spring expands to full diameter engaging a groove in the female part.

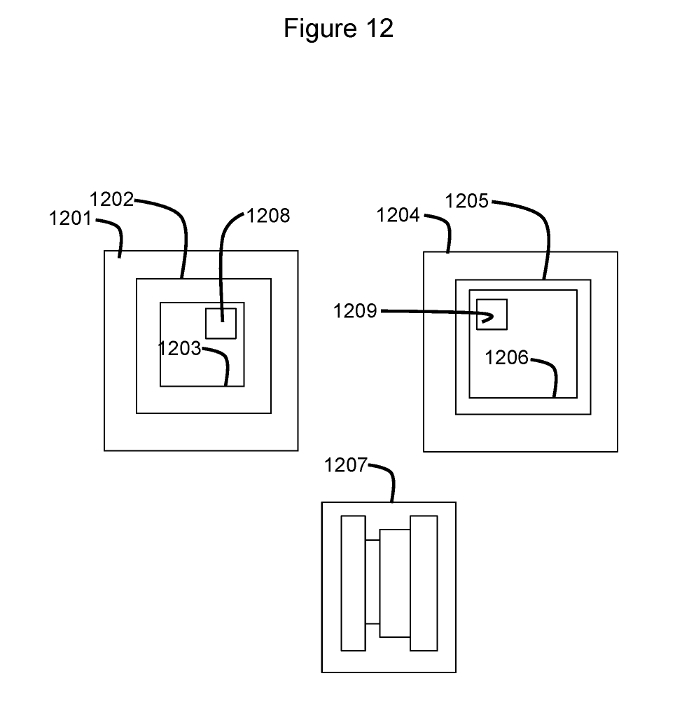

FIG. 12 shows a male object 1201 comprising a substrate 1202 and an attacher 1203. Further shown is a female object 1204 comprising a substrate 1205 and an attacher 1206. 1201 and 1202 can be connected together mechanically to form a connected assembly 1207. There is an information component on the male (1208) and female (1209) that notionally engage before, during, or after connection or disconnection.

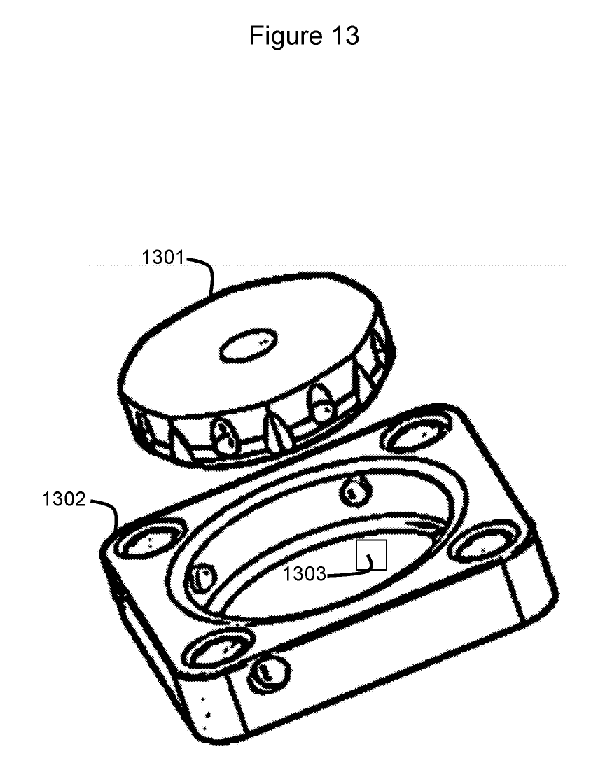

FIG. 13 shows a male object 1301 and a female object 1302, showing a male object that fastens to the female object using a Ball and Detent design. The male object has grooves and chamfer that fit into the cylindrical pocket of the female object. This works when the male object is placed in the female object, the female attacher springs are compressed, the male object in the enter/exist groove is then rotated where the male object and female attacher spring fits into the second retaining groove and decompresses locking the male object to the female object. Alternatively, the male is inserted into the female in an aligned or misaligned orientation such that the insertion chamfer compresses the plungers/spring until the retaining groove is encountered at which point the plunger and spring extends into the groove to secure the device rotationally, axially, and translationally. To unlock the male object is pushed up to female object, and rotated where the male object and female attacher spring is in the exit groove. A feature of the male engages with an information component on the female 1303 during and/or after connection, which may communicate information, power, or a signal between the components or to external components.

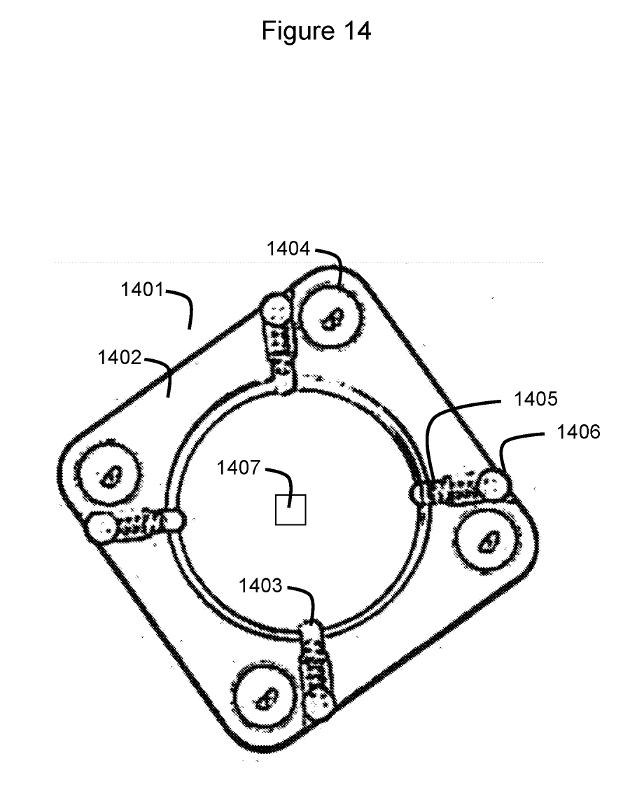

FIG. 14 shows the female object where the substrate 1401 holds the load bearing, the attacher 1402 is sandwiched in the substrate attached to the plungers 1403. The plunger as seen is compressed by the male object when the male object is placed in the female object. The stopper 1406 attaches to the spring 1405 with is attached to the plunger 1403. Fasteners 1404 attach the attacher to the substrate. A feature of the male engages with a contact on the female 1407 during and/or after connection, which may communicate information, power, or a signal between the components or to external components.

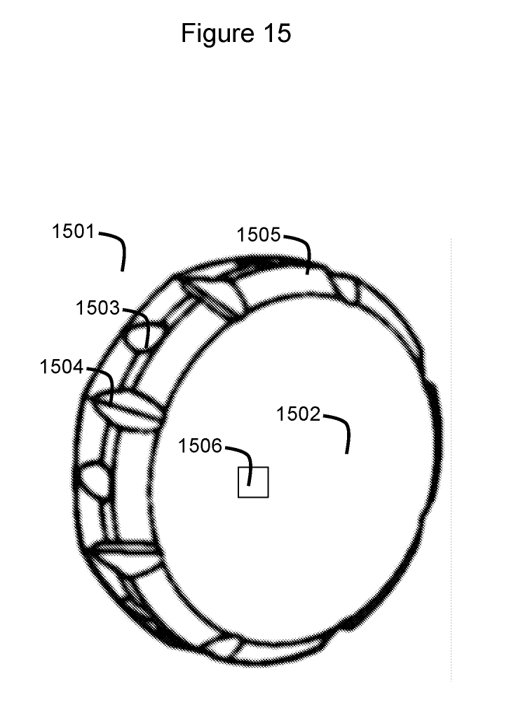

FIG. 15 shows a male object, the attacher 1502, attached to substrate 1501. The male object comprises one or a plurality of retaining grooves 1503, zero, one, or a plurality of exit grooves 1504, and an insertion chamfer 1505. It additionally comprises an electrical contact 1506.

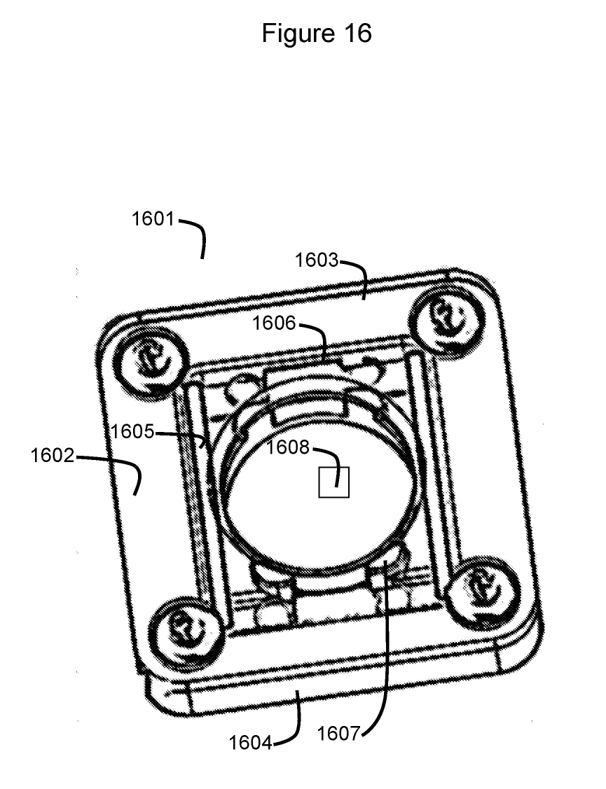

FIG. 16 shows a female object associated with a substrate 1601 comprising an attacher 1603, coverplate, 1602, retaining bar 1605, spring 1606, base 1604, and retaining bar limiter 1607. The male object is inserted into the female object and may or may not be rotated to lock into place as a retaining bar limiter behave like flaps. When inserted, the male and female objects are rotationally, axially, and translationally coupled. The springs 1606 apply a predetermined force to the retaining bars 1605. This force is chosen to optimize holding force, torque required for removal, and insertion force. There is a switch 1608 that is activated or deactivated by insertion of a male component into the female component, this switch communicating information between components or between the female component and external components.

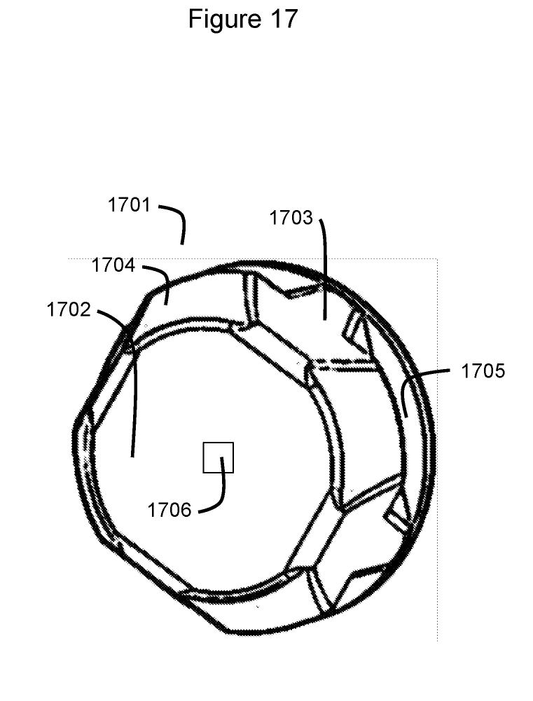

FIG. 17 shows a male component associated with a substrate 1701. The component comprising an attacher 1702, an insertion chamfer 1704, an exit chamfer 1703, a retaining groove 1705, and an indicator 1706. The insertion is such that the insertion chamfers contact the retaining bars and tension the springs. Upon full insertion the retaining bar engages with the retaining groove. To remove, the male and female are rotated relative to each other by somewhere between 25 and 335 degrees in order for the exit chamfer to be engaged. The exit chamfer may also serve to provide a ‘kick-out’ force when engaged by the retaining bar.

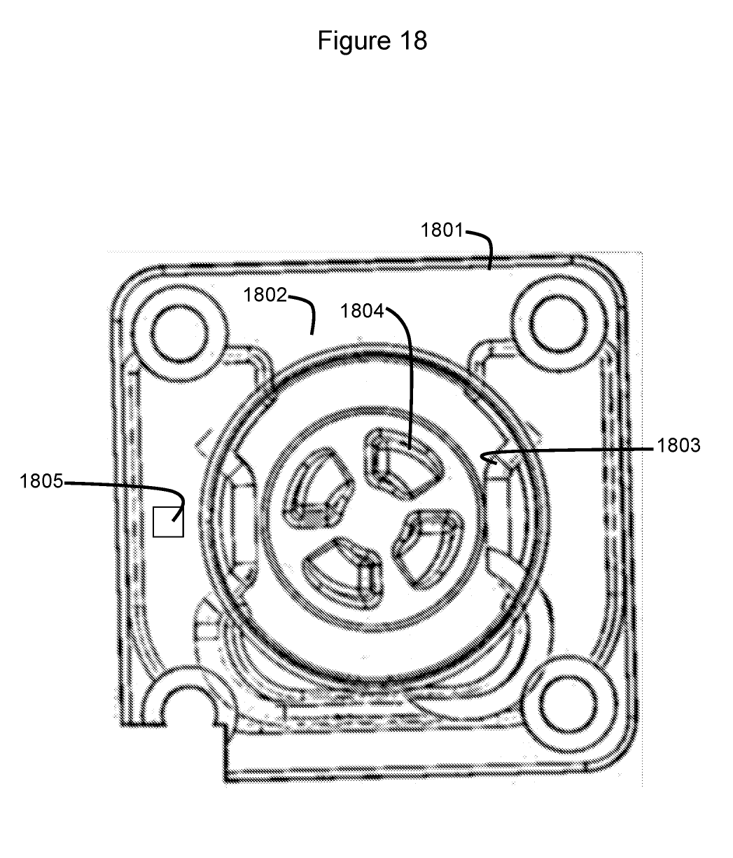

FIG. 18 shows a female component comprising an attacher 1801, coverplate 1802, guide feature 1804, spring clip 1803, and reader 1805. The reader can interrogate items. In one embodiment, the reader is an RFID reader.

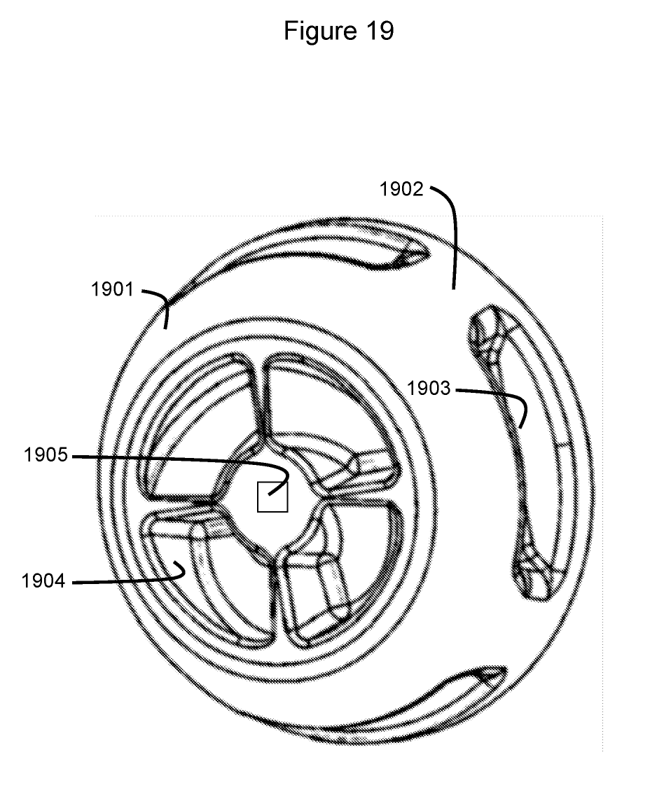

FIG. 19 shows a male component comprising an attacher 1902, insertion fillet 1901, retaining groove 1903, guide groove 1904, and identification component 1905. The male and female components engage such that upon axial insertion the spring clip is extended by the insertion fillet. Upon alignment of the retaining groove to the spring clip feature, the spring clip engages with the retaining groove locking the male and female components together. The guide grooves engage with the guide features to limit the orientation of insertion and removal. They further interact to translate rotational motion to axial motion upon removal, which is obtained by rotating the male and female with respect to each other. Thus, insertion may occur by a combination of axial, rotational, etc. motion and removal may occur by a combination of axial, rotational, etc. motion. In one embodiment, the identification component 1905 comprises an RFID tag.

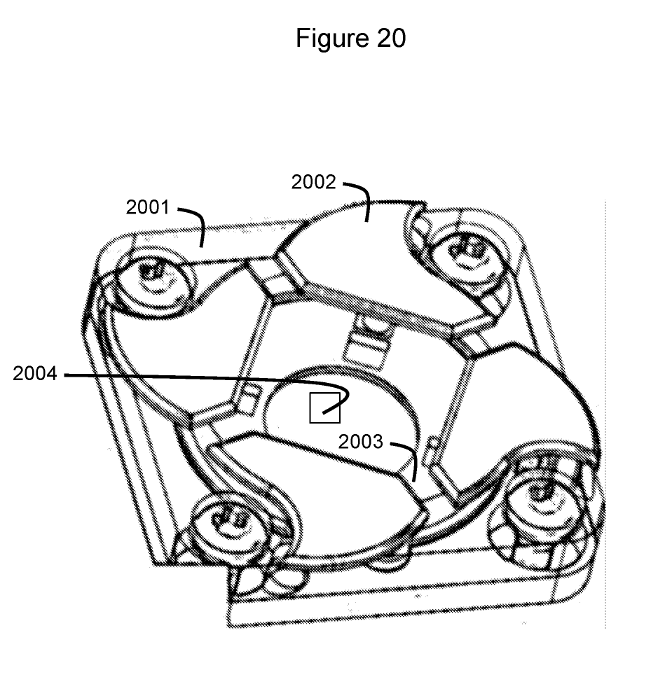

FIG. 20 shows a female component comprising an attacher 2001, wing 2002, lock plate 2003, and sensor 2004. The components are engaged with axial motion. The insertion chamfer on the male component engages with the wings on the female component, inducing the wings to radially retract and compress a spring. Upon insertion the wing engages with the retaining groove to hold the components in place relative to each other. Rotation without axial force will not disengage the wings from the retaining groove. Axial motion against the spring-loaded locking plate is required to disengage the locking groove from the locking plunger such that rotation can induce radial retraction of the wings. Upon removal of the male component, the device may be ‘preloaded’ such that the wings are in the retracted position with stored energy in the form of the spring. Upon insertion of the male which compresses the locking plate, the locking groove disengages and the wings spring radially inward. In one embodiment, the sensor 2004 is a magnetic field sensor.

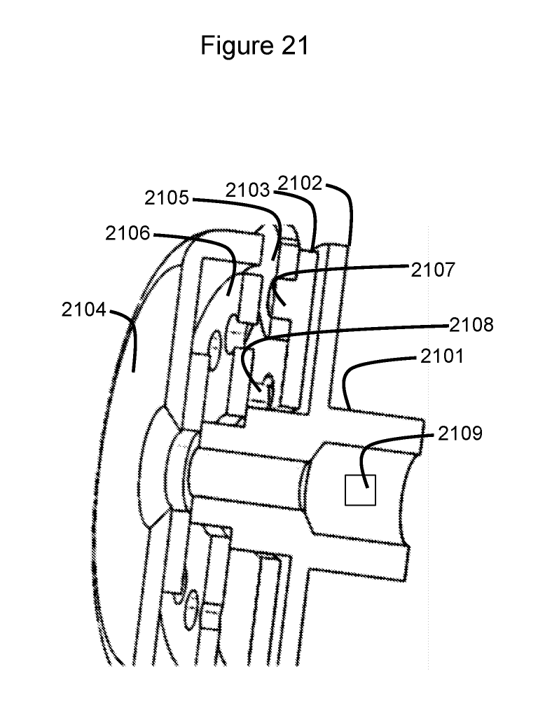

FIG. 21 shows a male component 2101. The component is shown in the ‘unloaded position’. The spring 2105 is connected to the base plate 2103 by the spring pin 2107, and to the spin wheel 2106 by a pin 2108. The face plate 2104 and plunger 2101 are coupled together. Upon rotation of the plunger with respect to the base plate, the spring is contracted as the two pins move relative to each other. The wheel pin, which engages with the base plate, rotates until it encounters a locking feature on the base plate upon which the device is rotationally rigid, and the spring preloaded such that the spring diameter is equal or less than the plunger diameter. Upon insertion into a female component, the plunger moves axially relative to the base plate, which disengages the wheel pin from the base plate and allows for free rotation. The stored energy of the spring is released, and the spring expands to full diameter engaging a groove in the female part. The component additionally comprising a sensed object 2109, which by means of example includes a predetermined electronic signal, a magnetic signal, or an optical signal.

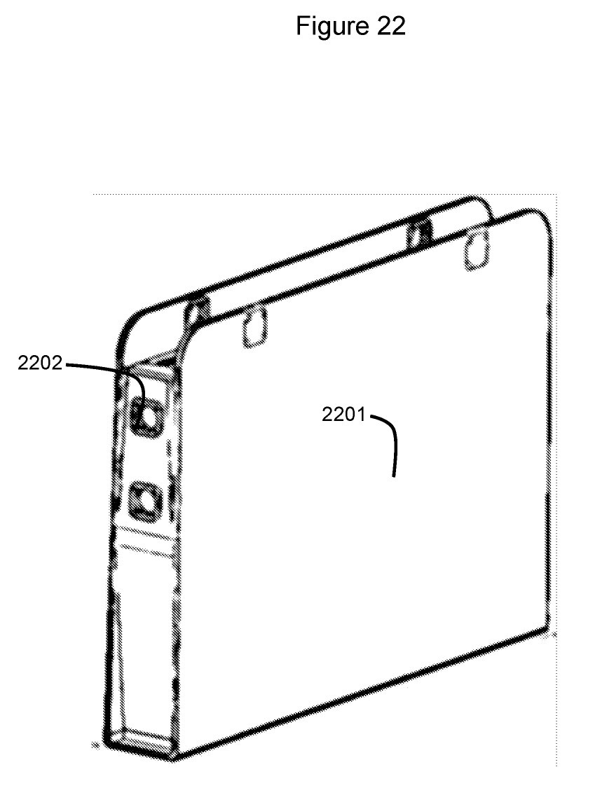

FIG. 22 shows a mobile object 2201 with one or a plurality of female components 2202. The mobile object by means of example is a bag, or by further means of example a handbag.

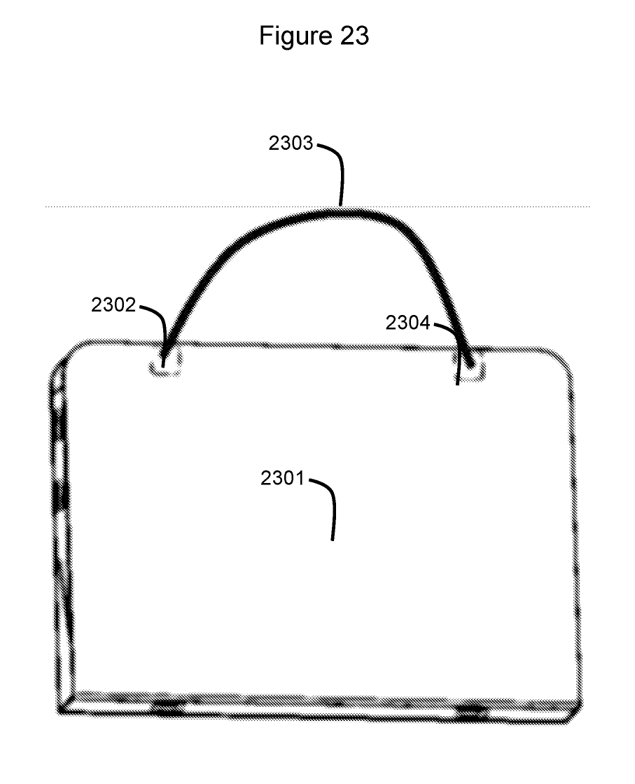

FIG. 23 shows a mobile object 2301 with at least one female component 2302 and a handle 2303 associated with at least one male component 2304

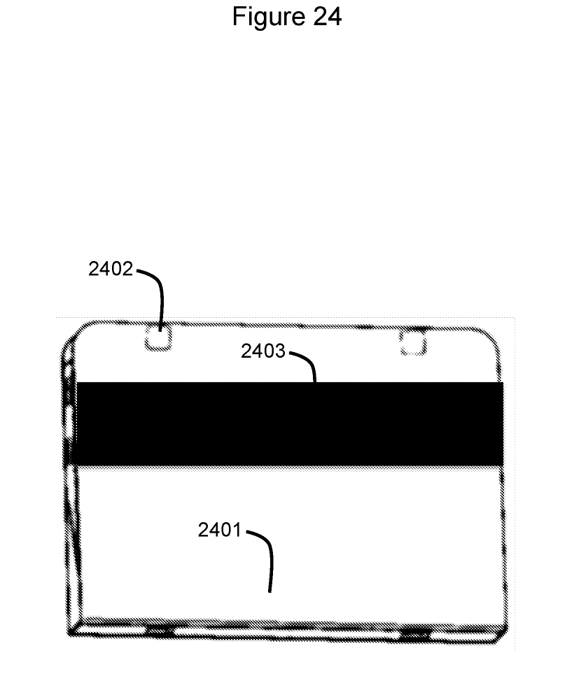

FIG. 24 shows a mobile object 2401 with at least one female component 2402 and a strap 2403, said strap associated with at least one male component.

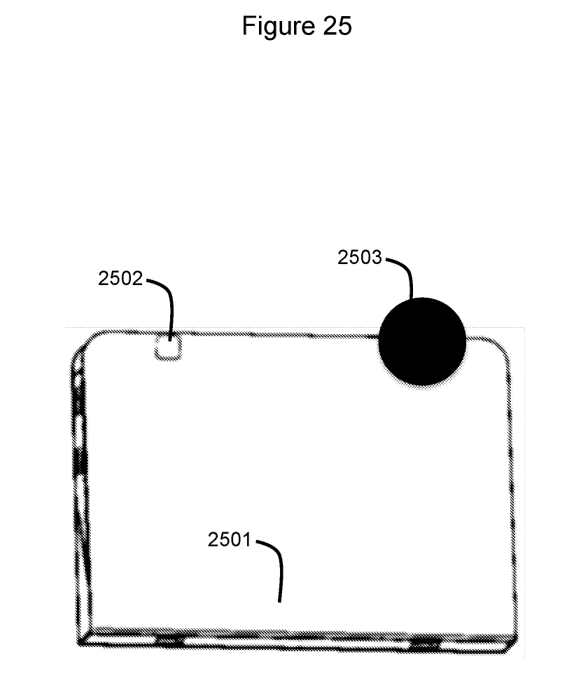

FIG. 25 shows a mobile object 2501 with at least one female component 2502 and an accessory 2503, said accessory associated with at least one male component.

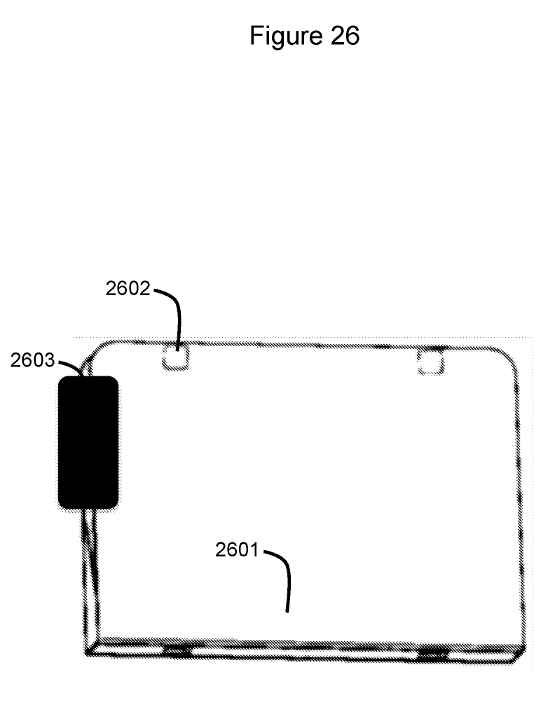

FIG. 26 shows a mobile object 2601 with at least one female component 2602 and a mobile phone 2603, said mobile phone associated with at least one male component. By means of example, the mobile object 2601 may be a bag, a handbag, or a suitcase.

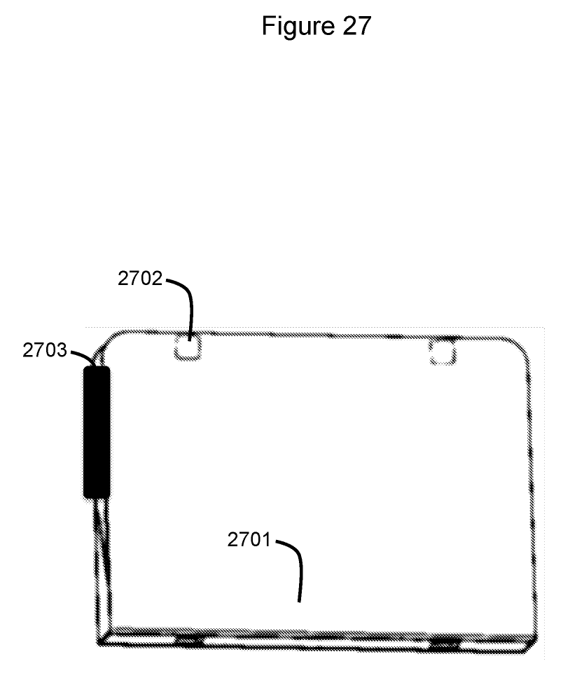

FIG. 27 shows a mobile object 2701 with at least one female component 2702 and keys 2703 associated with at least one male component.

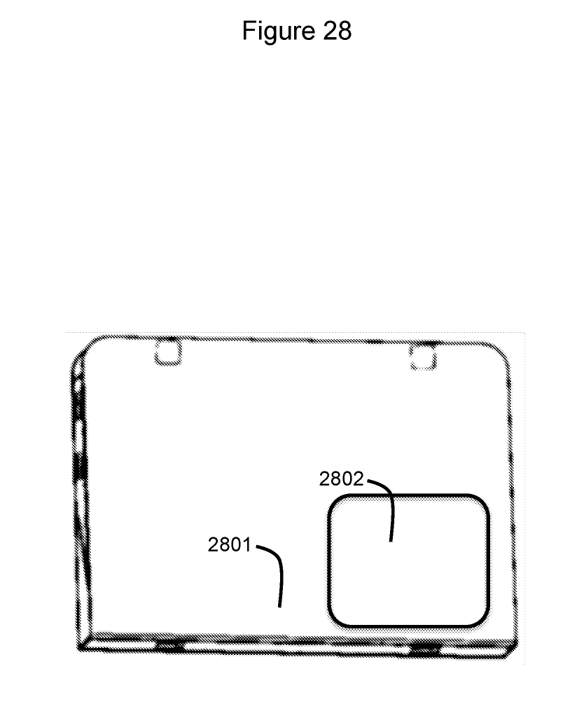

FIG. 28 shows a mobile object 2801 with an embedded antenna 2802.

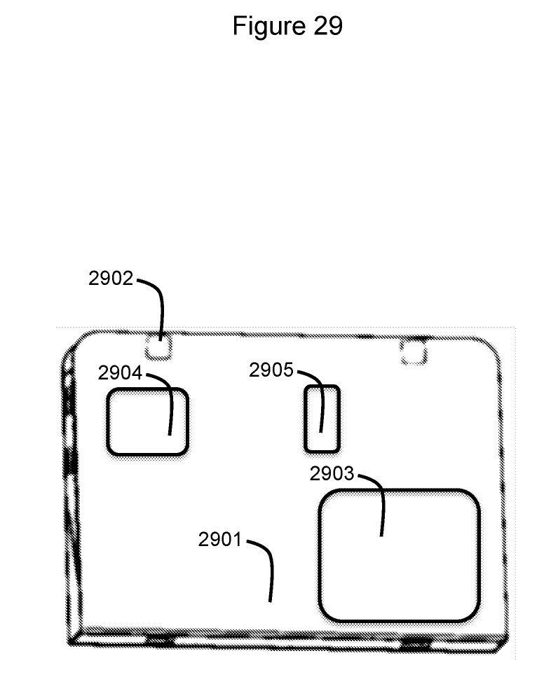

FIG. 29 shows a mobile object 2901 having at least one female component 2902 with an embedded antenna 2903, a battery 2905, and a transmitter 2904.

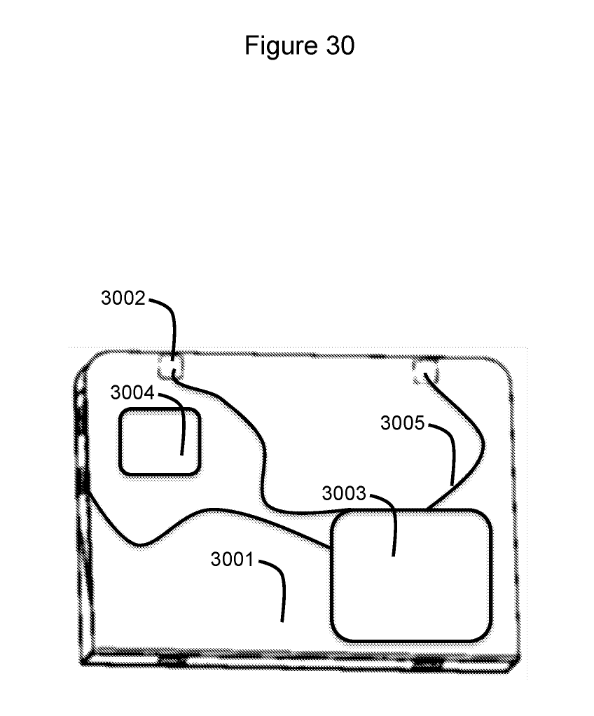

FIG. 30 shows a mobile object 3001 with a battery 3003, a transmitter 3004, and wires 3005 associated with at least one female component 3002.

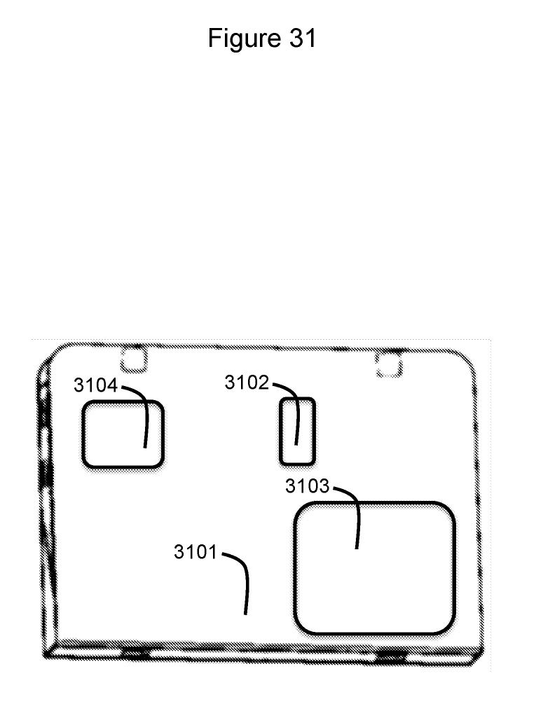

FIG. 31 shows a mobile object 3101 with an antenna 3103, a battery 3104, and a storage device 3102.

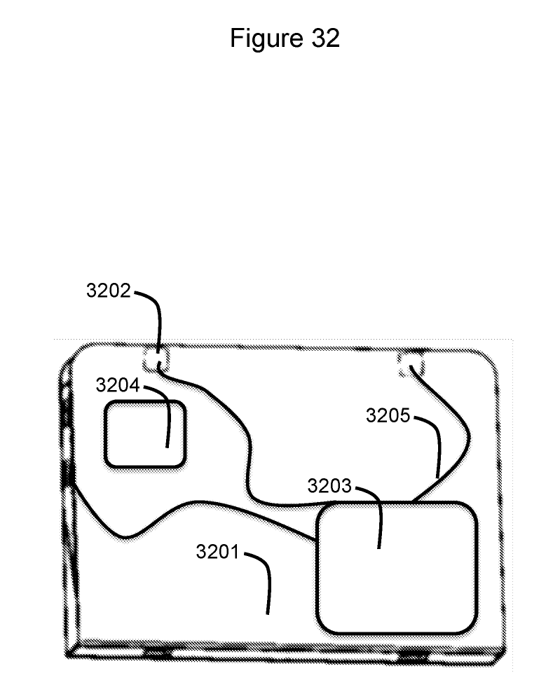

FIG. 32 shows a bag 3201 with a storage device 3203, battery 3204, and wires 3205 associated with at least one female object 3202.

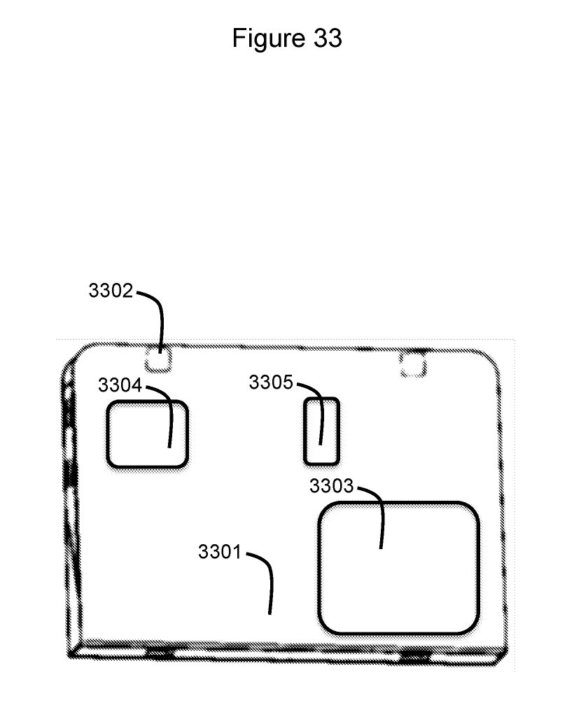

FIG. 33 shows a mobile object 3301 comprising at least one female component 3301 with a processor 3305, battery 3304, and reader 3303. By means of example, said reader may be an RFID reader, Bluetooth reader, WiFi device, or more. By means of example the processor may be a microprocessor, FPGA, semiconductor device, or more.

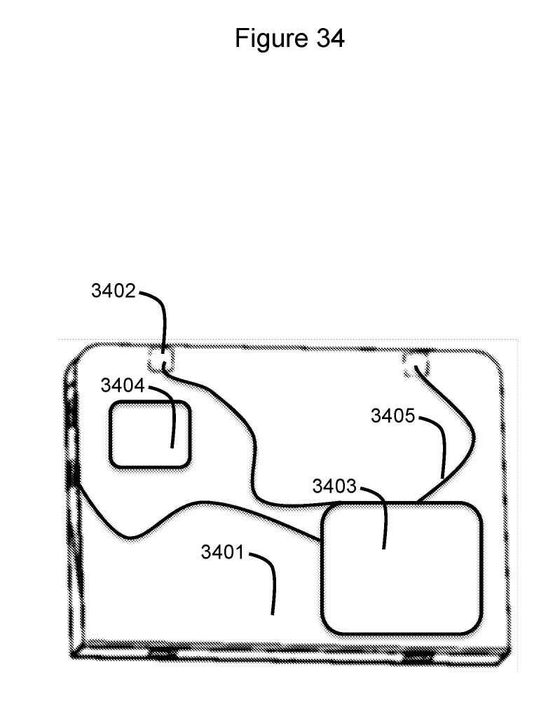

FIG. 34 shows a mobile object 3401 with a processor 3404, battery 3403, and wires 3405 associated with at least one male object 3402. Said male object may, by means of example, be a Ball and Detent component.

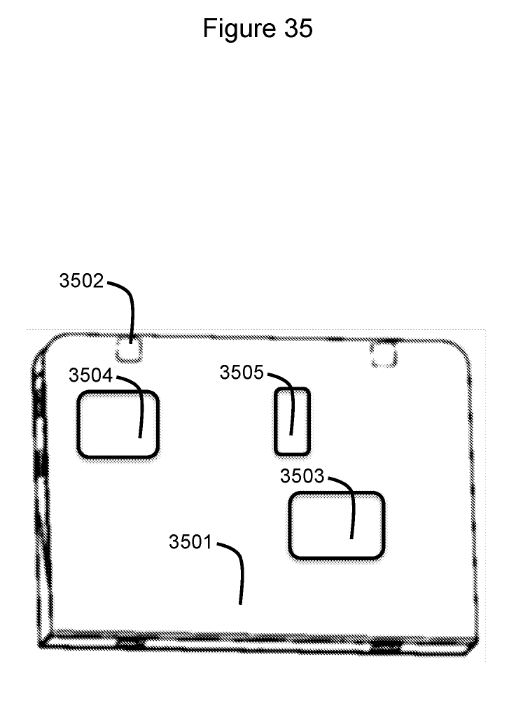

FIG. 35 shows a mobile object 3501 having at least one female component 3502 with a battery 3504, antenna 3503, and transceiver 3505.

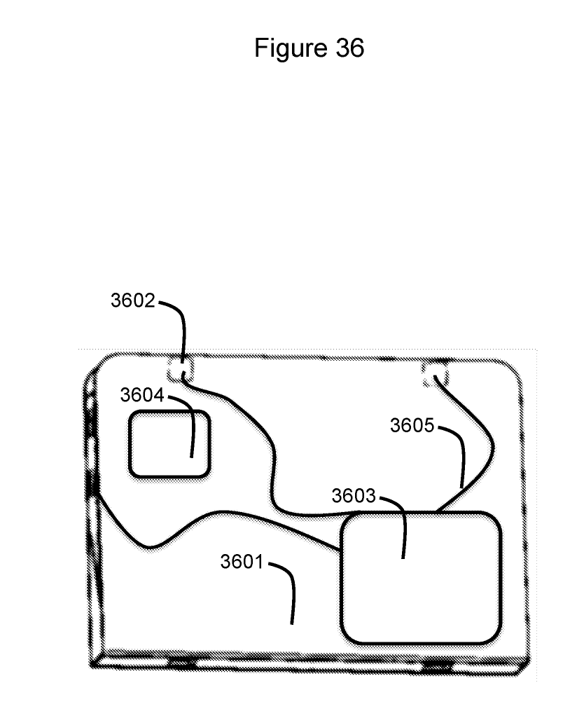

FIG. 36 shows a mobile object 3601 having at least one female component 3502 and comprising a battery 3604, a transceiver 3603, and wires 3605.

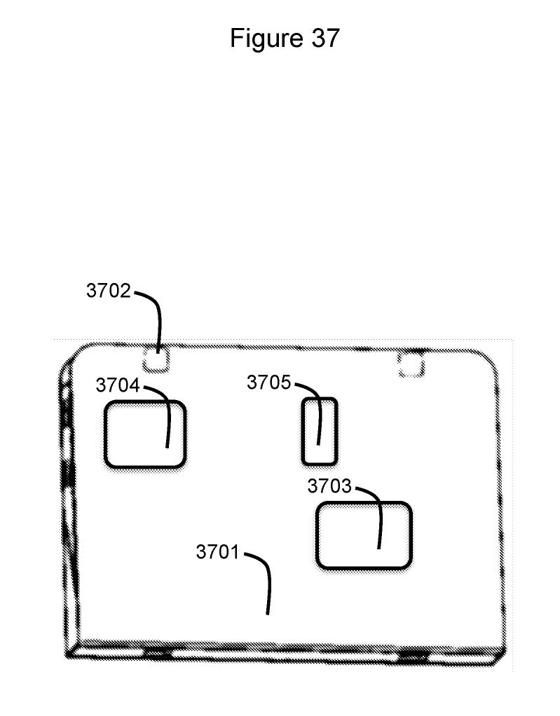

FIG. 37 shows a bag 3701 with a fuel cell 3703, antenna 3704, and transmitter 3705. The bag additionally comprising at least one female component 3702.

The inventions may be embodied in other forms than those specifically disclosed herein without departing from its spirit or essential characteristics. The described embodiments are to be considered in all respects only as illustrative and not restrictive.

What is claimed:

1. A fastener comprising:
a. A female component comprising an information component;
b. A male component comprising an information component;
c. A first substrate associated with the female component;
d. A second substrate associated with the male component;
e. whereby the male and female component communicate information via the information components.

2. The fastener of claim 1 whereby:
a. The female component is made of metal;
b. The male component is made of metal;
c. The information component is made of metal.

3. The fastener of claim 1 whereby:
a. The male component has at least one groove;
b. The male component has at least one chamfer;
c. The female component has a pocket of substantially cylindrical geometry;
d. Whereby the male component being placed in the female component at least one spring is compressed;

4. The fastener of claim 1 whereby the information communicated is communicated wirelessly.

5. The fastener of claim 4 whereby the wireless communication is radio frequency.

6. The fastener of claim 4 whereby the wireless communication is induction.

7. The fastener of claim 4 whereby the wireless communication is Bluetooth.

8. The fastener of claim 1 whereby the female component has:
a. An attacher;
b. A plunger;
c. A spring;
d. A stopper;
e. A substrate;
f. Whereby the spring applies a predetermined force to the plunger.

9. The fastener of claim 1 whereby the male component comprises:
a. An attacher;
b. One or more retaining grooves;
c. A chamfer;
d. A substrate.

10. The fastener of claim 1 whereby the female component comprises:
a. A substrate;
b. An attacher;
c. A coverplate;
d. A retaining bar;
e. A spring;
f. Whereby the spring applies a predetermined force to the retaining bar.

11. The fastener of claim 1 whereby the male component comprises an information component comprising a contact whereby the contact is electronically conductive.

12. The fastener of claim 1 whereby the female component comprises and information component comprising a switch.

13. The fastener of claim 1 whereby the male component comprises an information component comprising an indicator whereby the indicator is a mechanical component that activates a switch.

14. The fastener of claim 1 whereby the female component comprises and information component comprising a reader.

15. The fastener of claim 18 whereby the reader is an RFID reader.

16. The fastener of claim 18 whereby the reader is an induction reader.

17. The fastener of claim 1 male component comprises an information component comprising an identification tag.

18. The fastener of claim 22 whereby the identification tag is an RFID tag.

19. The fastener of claim 1 whereby the female component comprises and information component comprising a sensor.

20. The fastener of claim 24 whereby the sensor is a magnetic field sensor.

21. The fastener of claim 1 male component comprises an information component comprising a sensed object.

22. The fastener of claim 26 whereby the sensed object is magnetic.

23. The fastener of claim 1 whereby the substrate is comprised of a mobile object.

24. The fastener of claim 36 whereby the mobile object is a bag.

25. The fastener of claim 36 whereby the mobile object is a cart.

26. The fastener of claim 36 whereby the mobile object is a suitcase.

27. The fastener of claim 1 whereby the first substrate is a wall.

28. The fastener of claim 1 whereby the first substrate is a rack.

29. The fastener of claim 1 whereby the first substrate is a dashboard.

30. The fastener of claim 1 whereby
a. the first substrate is a wall;
b. the second substrate is an article of clothing;

31. The fastener of claim 1 whereby
a. the first substrate is a wall;
b. the second substrate is one or more keys;

32. The fastener of claim 1 whereby
a. the first substrate is a bag;
b. the second substrate Is a mobile phone;

33. The fastener of claim 1 whereby
a. the first substrate is a bag;
b. the second substrate is an accessory;

34. The fastener of claim 1 whereby
a. the first substrate is a bag;
b. the second substrate is a strap;

35. The fastener of claim 1 whereby
a. the first substrate is a bag;
b. the second substrate is a handle;

36. A mobile object comprising a female component; the female component comprising an attacher.

37. The mobile object of claim 53 whereby the mobile object is a bag.

38. The mobile object of claim 53 whereby the female component comprises an information component.

39. The mobile object of claim 53 whereby the female component comprises:
a. A plunger;
b. A spring;
c. A stopper;
d. A substrate;
e. Whereby the spring applies a predetermined force to the plunger.

40. The mobile object of claim 53 whereby the female component comprises:
a. A spring;
b. A retaining bar;
c. Whereby the spring applies a predetermined force to the retaining bar.

41. The bag of claim 54 whereby the female component comprises:
a. A plunger;
b. A spring;
c. A stopper;
d. A substrate;
e. Whereby the spring applies a predetermined force to the plunger.

42. The bag of claim 54 whereby the female component comprises:
a. A spring;
b. A retaining bar;
c. Whereby the spring applies a predetermined force to the retaining bar.

43. The mobile object of claim 53 whereby the mobile object is a suitcase.

44. The mobile object of claim 53 whereby the mobile object comprises an embedded antenna.

45. The mobile object of claim 53 whereby the mobile object comprises a battery, a transmitter, and wires.

46. The mobile object of claim 53 whereby the mobile object comprises a battery, a processor, and a reader.

47. The mobile object of claim 66 whereby the reader is an RFID reader.

48. The mobile object of claim 66 whereby the reader is a Bluetooth reader.

49. A mobile object comprising a male component; the male component comprising an attacher.

50. The mobile object of claim 70 whereby the mobile object comprises a battery, a processor, and wires.
